(19) United States
(12) Patent Application Publication
(10) Pub. No.: US 2015/0231911 A1
(43) Pub. Date: Aug. 20, 2015

(54) CUSTOMIZABLE WINE LABEL

(71) Applicant: Golden Glass Wine, LLC, Glendale, AZ (US)

(72) Inventor: Kyle Smith, Glendale, AZ (US)

(73) Assignee: Golden Glass Wine, LLC, Glendale, AZ (US)

(21) Appl. No.: 14/209,895

(22) Filed: Mar. 13, 2014

Related U.S. Application Data
(60) Provisional application No. 61/941,715, filed on Feb. 19, 2014.

(51) Int. Cl. B42D 15/00

(52) U.S. Cl. CPC B42D 15/00

(57) ABSTRACT

A customizable wine label is provided. The customizable wine label includes a first label coupled to a bottle of wine and a second label coupled to the bottle of wine on a side of the bottle of wine opposing the first label. The first label includes written indicia preselected to indicate a type of gift the bottle of wine is intended for. The second label comprises a customizable portion for receiving user entered written indicia. The preselected written indicia correspond to and coordinates with the type of wine in the bottle of wine.

### CROSS REFERENCE TO RELATED APPLICATION[S]

This application claims priority to U.S. Provisional Patent Application to “CUSTOMIZABLE WINE LABEL,” Ser. No. 61/941,715, filed Feb. 19, 2014, now pending, the disclosure of which is hereby incorporated entirely herein by reference.

### BACKGROUND OF THE INVENTION

1. Technical Field

This invention relates generally to wine label and more particularly to a wine label system for user customization.

2. State of the Art

Wine has been the source of celebration for years. In particular, wine has been utilized as a gift for various occasions, such as birthday gifts, Christmas gifts, thank you gifts, and other types of gifts from one person to another in order to show appreciation for another person. Conventionally, when giving a bottle of wine to another, a user would also purchase a card. The user then writes onto the card a desired message to express specific thoughts and feelings on the card for the recipient to read. Another way of providing a customized message with a bottle of wine as a gift is to purchase a bag or wine bottle gift box with an attached card, wherein the user may then write a customized message to the recipient. In each instance, it requires the purchase of another item in order to provide a customized message.

Accordingly, there is a need in the field of wine bottle labels for an improved label that allows for user message customization.

### DISCLOSURE OF THE INVENTION

The present invention relates to a customizable wine label, wherein the wine label contains a customizable portion for user entered indicia. The customizable wine label further includes predetermined written indicia in order to designate the type of gift for which the particular bottle of wine would be appropriate.

Embodiments of the present invention include a customizable wine label having a first label coupled to a bottle of wine, wherein the first label includes written indicia preselected to indicate a type of gift the bottle of wine is intended for; and a second label coupled to the bottle of wine on a side of the bottle of wine opposing the first label, wherein the second label comprises a customizable portion for receiving user entered written indicia.

Embodiments of the present invention include a method of using a customizable wine label. The method may comprise providing bottle of wine comprising: a first label coupled to the bottle of wine, wherein the first label includes written indicia preselected to indicate a type of gift the bottle of wine is intended for; and a second label coupled to the bottle of wine on a side of the bottle of wine opposing the first label, wherein the second label comprises a customizable portion for receiving user entered written indicia; selecting a type of wine in response to selecting a particular preselected written indicia, wherein the particular preselected written indicia corresponds to and coordinates with the type of wine in the bottle of wine; and applying a customized user entered written indicia in the customizable portion of the second label.

The foregoing and other features and advantages of the present invention will be apparent from the following more detailed description of the particular embodiments of the invention, as illustrated in the accompanying drawings.

### BRIEF DESCRIPTION OF THE DRAWINGS

FIG. 1 is a view of a first label of a customizable wine label indicating a first type of gift the bottle of wine is intended for.

FIG. 2 is a view of a second label of the customizable wine label of FIG. 1.

FIG. 3 is a view of a first label of a customizable wine label type of a second type of gift the bottle of wine is intended for.

FIG. 4 is a view of a second label of the customizable wine label of FIG. 3.

FIG. 5 is a view of a first label of a customizable wine label a third type of gift the bottle of wine is intended for.

FIG. 6 is a view of a second label of the customizable wine label of FIG. 5.

### DETAILED DESCRIPTION OF EMBODIMENTS OF THE INVENTION

As discussed above, embodiments of the present invention relate to a customizable wine label, wherein the wine label contains a customizable portion for user entered indicia. The customizable wine label further includes predetermined written indicia in order to designate the type of gift for which the particular bottle of wine would be appropriate.

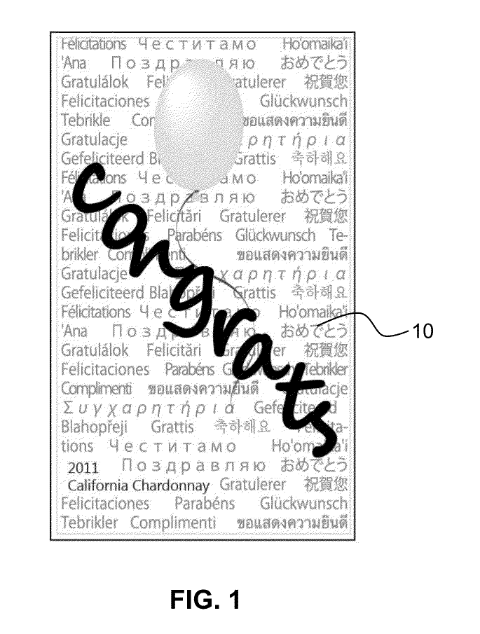

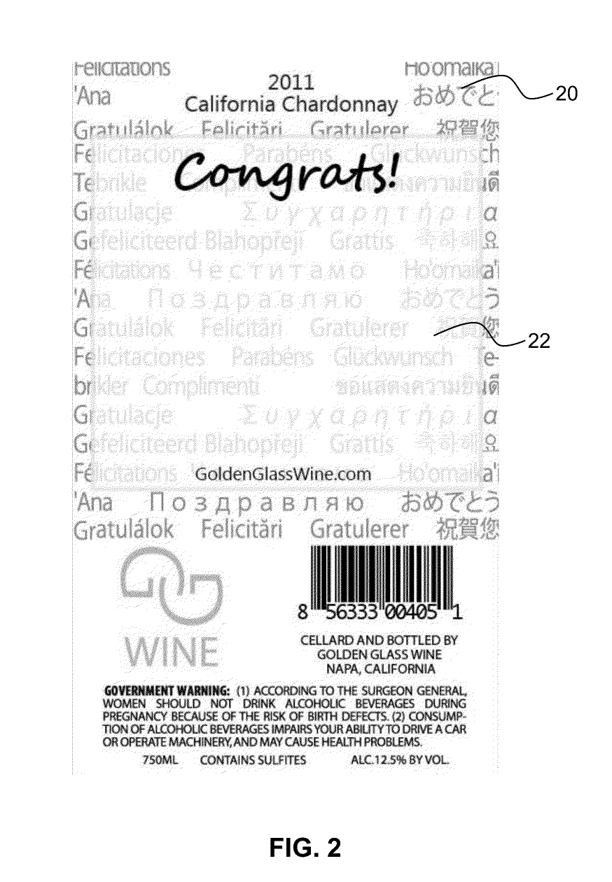

As shown in FIGS. 1 and 2, the customizable wine label comprises a first label 10 and second label 20. The first label 10 may include written indicia preselected to indicate a type of gift the bottle of wine is intended for. The written indicia may further include graphics and text. Referring to FIG. 1 as an example, and not by way of limitation, the type of gift presented is a congratulatory gift denoted by text of “congrats” and a balloon graphic.

The second label 20 comprises a customizable portion 22 for receiving user entered written indicia. A user may write directly onto the second label 20 in the customizable portion 22 a message intended for a recipient of the bottle of wine as the gift. The second label may also include preselected written indicia that also indicate the type of gift the bottle of wine is intended for. This serves to alert and remind the user what the intended gift of wine is for to assist the user in determining the customized written indicia that the user applies to the customizable portion. The user may apply written indicia as hand written indicia. The preselected written indicia on the second label 22 may correspond to the preselected written indicia of the first label 10.

The preselected written indicia of the first label 10 and the second label 20 may further correspond to and coordinate with the type of wine in the bottle of wine. For example, and without limitation, FIGS. 1 and 2 indicate that a chardonnay is an appropriate wine to say congratulations to the recipient.

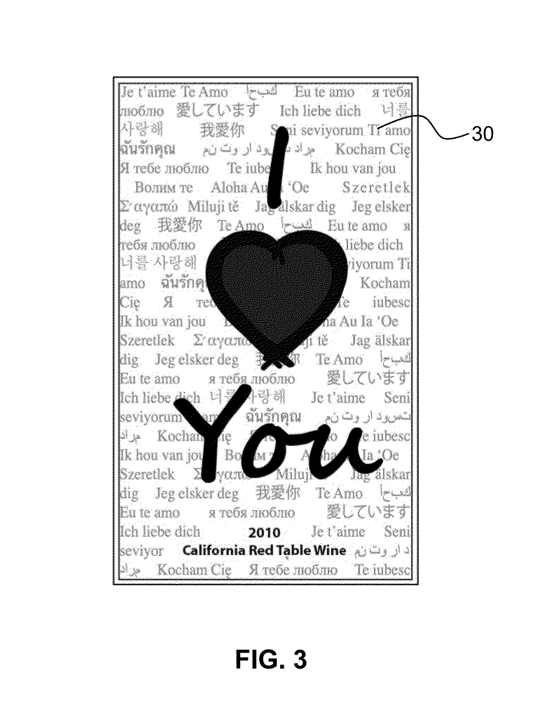

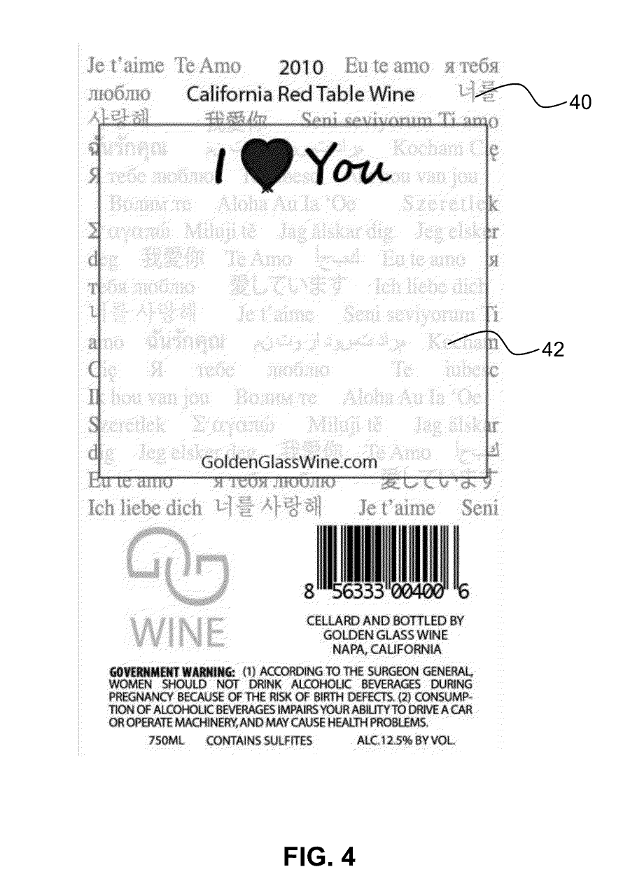

As shown in FIGS. 3 and 4, the customizable wine label comprises a first label 30 and second label 40. The first label 30 may include written indicia preselected to indicate a type of gift the bottle of wine is intended for. The written indicia may further include graphics and text. Referring to FIG. 3 as an example, and not by way of limitation, the type of gift presented is a gift for a significant other or person loved by the user denoted by text and graphic of “I Love You” where a heart is depicted in the place of the text “Love.”

The second label 40 comprises a customizable portion 42 for receiving user entered written indicia. A user may write directly onto the second label 40 in the customizable portion 42 a message intended for a recipient of the bottle of wine as the gift. The second label may also include preselected written indicia that also indicate the type of gift the bottle of wine is intended for. This serves to alert and remind the user what the intended gift of wine is for to assist the user in determining the customized written indicia that the user applies to the customizable portion 42. The user may apply written indicia as hand written indicia. The preselected written indicia on the second label 42 may correspond to the preselected written indicia of the first label 30.

The preselected written indicia of the first label 30 and the second label 40 may further correspond to and coordinate with the type of wine in the bottle of wine. For example, and without limitation, FIGS. 3 and 4 indicate that a red table wine is an appropriate wine to say I love you to the recipient.

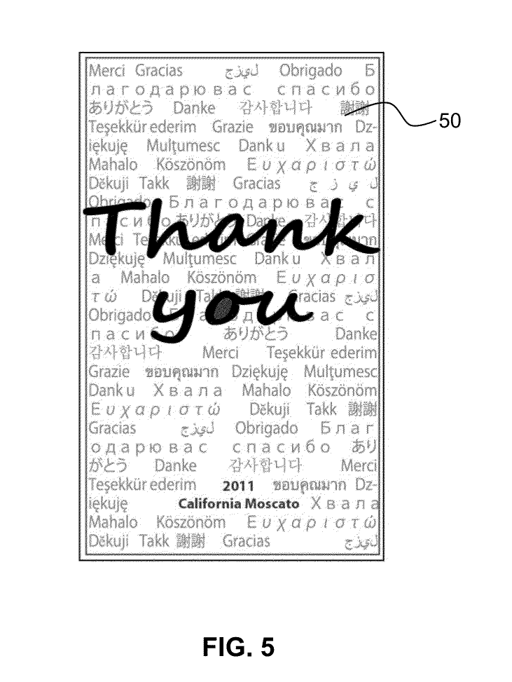

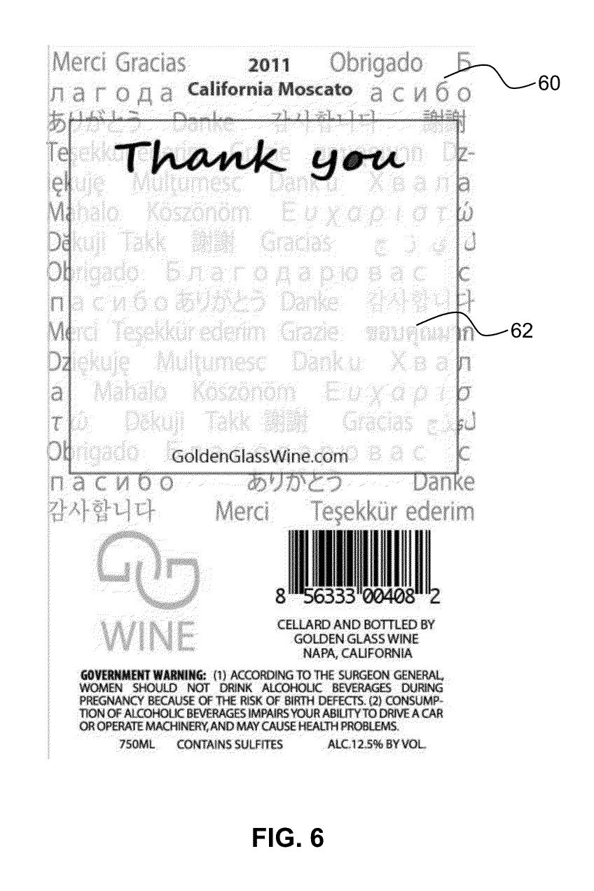

As shown in FIGS. 5 and 6, the customizable wine label comprises a first label 50 and second label 60. The first label 50 may include written indicia preselected to indicate a type of gift the bottle of wine is intended for. The written indicia may further include graphics and text. Referring to FIG. 5 as an example, and not by way of limitation, the type of gift presented is a thank you gift denoted by text “Thank You.”

The second label 60 comprises a customizable portion 62 for receiving user entered written indicia. A user may write directly onto the second label 60 in the customizable portion 62 a message intended for a recipient of the bottle of wine as the gift. The second label may also include preselected written indicia that also indicate the type of gift the bottle of wine is intended for. This serves to alert and remind the user what the intended gift of wine is for to assist the user in determining the customized written indicia that the user applies to the customizable portion 62. The user may apply written indicia as hand written indicia. The preselected written indicia on the second label 62 may correspond to the preselected written indicia of the first label 50.

The preselected written indicia of the first label 50 and the second label 60 may further correspond to and coordinate with the type of wine in the bottle of wine. For example, and without limitation, FIGS. 5 and 6 indicate that a moscato is an appropriate wine to say thank you to the recipient.

With regard to FIGS. 1-6, the first wine label 10, 30 or 50 is coupled to a bottle of wine (not shown). The second wine label 20, 40 or 60 is coupled to the bottle of wine on a side of the bottle of wine opposing the first label 10, 30 or 50 respectively.

Another embodiment of the present invention includes a method of using a customizable wine label. The method includes a step of providing bottle of wine comprising a first label coupled to the bottle of wine, wherein the first label includes written indicia preselected to indicate a type of gift the bottle of wine is intended for; and a second label coupled to the bottle of wine on a side of the bottle of wine opposing the first label, wherein the second label comprises a customizable portion for receiving user entered written indicia. The method further includes a step of selecting a type of wine in response to selecting a particular preselected written indicia, wherein the particular preselected written indicia corresponds to and coordinates with the type of wine in the bottle of wine. Further still, the method includes a step of applying a customized user entered written indicia in the customizable portion of the second label.

According to embodiments of the method, the step of applying the customized user entered written indicia comprises applying hand written indicia.

In embodiments of the method, the step of selecting the type of wine in response to selecting a particular preselected written indicia may comprise selecting a chardonnay in response to selecting the preselected written indicia that invokes congratulations. The step of selecting the type of wine in response to selecting a particular preselected written indicia may comprise selecting a red wine in response to selecting the preselected written indicia that invokes I love you. The step of selecting the type of wine in response to selecting a particular preselected written indicia may comprise selecting a moscato in response to selecting the preselected written indicia that invokes thank you.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A customizable wine label comprising:
a first label coupled to a bottle of wine, wherein the first label includes written indicia preselected to indicate a type of gift the bottle of wine is intended for; and
a second label coupled to the bottle of wine on a side of the bottle of wine opposing the first label, wherein the second label comprises a customizable portion for receiving user entered written indicia.

2. The customizable wine label of claim 1, wherein the customizable portion of the second label is configured to receive hand written indicia.

3. The customizable wine label of claim 1, wherein the second label comprises preselected written indicia that also indicate the type of gift the bottle of wine is intended for, wherein the preselected written indicia of the second label corresponds to the preselected written indicia of the first label.

4. The customizable wine label of claim 1, wherein the preselected written indicia of the first label correspond to and coordinate with the type of wine in the bottle of wine.

5. The customizable wine label of claim 4, the preselected written indicia invokes congratulations and corresponds to and coordinates with a chardonnay.

6. The customizable wine label of claim 4, the preselected written indicia invokes I love you and corresponds to and coordinates with a red wine.

7. The customizable wine label of claim 4, the preselected written indicia invokes thank you and corresponds to and coordinates with a moscato.

8. The customizable wine label of claim 1, wherein the preselected written indicia comprises written text.

9. The customizable wine label of claim 8, wherein the preselected written indicia comprises graphics.

10. A method of using a customizable wine label, the method comprising:
providing a bottle of wine comprising:
a first label coupled to the bottle of wine, wherein the first label includes written indicia preselected to indicate a type of gift the bottle of wine is intended for; and
a second label coupled to the bottle of wine on a side of the bottle of wine opposing the first label, wherein the second label comprises a customizable portion for receiving user entered written indicia;
selecting a type of wine in response to selecting a particular preselected written indicia, wherein the particular preselected written indicia corresponds to and coordinates with the type of wine in the bottle of wine; and
applying a customized user entered written indicia in the customizable portion of the second label.

11. The method of claim 10, wherein applying the customized user entered written indicia comprises applying hand written indicia.

12. The method of claim 10, wherein the second label comprises preselected written indicia that also indicate the type of gift the bottle of wine is intended for, wherein the preselected written indicia of the second label corresponds to the preselected written indicia of the first label.

13. The method of claim 10, wherein the selecting the type of wine in response to selecting a particular preselected written indicia comprises selecting a chardonnay in response to selecting the preselected written indicia that invokes congratulations.

14. The method of claim 10, wherein the selecting the type of wine in response to selecting a particular preselected written indicia comprises selecting a red wine in response to selecting the preselected written indicia that invokes I love you.

15. The method of claim 10, wherein the selecting the type of wine in response to selecting a particular preselected written indicia comprises selecting a moscato in response to selecting the preselected written indicia that invokes thank you.

16. The method of claim 10, wherein the preselected written indicia comprises written text.

17. The method of claim 16, wherein the preselected written indicia comprises graphics.
